(19) United States
(12) Patent Application Publication
(10) Pub. No.: US 2008/0279280 A1
(43) Pub. Date: Nov. 13, 2008

(54) MOVING PICTURE DECODING INTEGRATED CIRCUIT

(76) Inventors: Masayasu IGUCHI, Hyogo (JP); Jun TAKAHASHI, Kyoto (JP)

Correspondence Address: MCDERMOTT WILL & EMERY LLP, 600 13TH STREET, NW, WASHINGTON, DC, 20005-3096, US

(21) Appl. No.: 12/047,897

(22) Filed: Mar. 13, 2008

(30) Foreign Application Priority Data
May 7, 2007 (JP) 2007-122623

(51) Int. Cl. H04N 7/26

(52) U.S. Cl. 375/240.16; 375/E07.123

(57) ABSTRACT

A moving picture decoding device includes a cache memory for storing a reference picture, in addition to a multi-frame memory (external memory) for storing reference pixel data of a plurality of reference pictures, for processing of a HD image size large in angle of view. A reference structure analyzer analyzes the reference structure of pictures. A reference picture manager not only writes a reference picture high in the possibility of being referred to by an object picture to be decoded in the multi-frame memory but also stores such a reference picture in the cache memory, using the analysis results of the picture reference structure. This minimizes the capacity of the cache memory and also reduces the data transfer amount from the external memory.

### CROSS-REFERENCE TO RELATED APPLICATIONS

This non-provisional application claims priority under 35 U.S.C. §119(a) on Patent Application No. 2007-122623 filed in Japan on May 7, 2007, the entire contents of which are hereby incorporated by reference.

### BACKGROUND OF THE INVENTION

The present invention relates to a moving picture decoding device that reduces the bus bandwidth to/from an image data storage memory in playback of a moving picture stream.

In recent years, with the advent of the multimedia age in which pixel values of sound, images and the like are handled in an integrated manner, the conventional information media, that is, the means for conveying information to people such as newspapers, magazines, TVs, radios and phones have increasingly become taken up as subjects of multimedia. In general, the multimedia refers to simultaneous expression of, not only characters, but also graphics, sound, and especially images, for example, in association with one another. In this relation, to handle the conventional information media as subjects of multimedia, such information must essentially be expressed in a digital format.

However, in estimation of the information amounts of the respective information media described above in a digital format, it is found that, while the information amount is 1 to 2 bytes per character for a text, an information amount of 64 Kbits per second will be required for sound (phone quality), and even more, an information amount of 100 Mbits or more per second will be required for a moving picture (current TV reception quality). It is therefore unrealistic to handle such a huge amount of information in a digital format as it is in the above information media. While videophones, for example, have already been put into practical use via an integrated services digital network (ISDN) having a transmission speed of 64 Kits/s to 1.5 Mbits/s, it is impossible to send an image taken by a TV camera via ISDN as it is.

To address the above problem, information compression technology has become necessary. For example, in videophones, H.261 and H.263 moving picture compression technologies recommended by the International Telecommunication Union-Telecommunication Standard Standardization Sector (ITU-T) have been used. Also, according to MPEG-1 information compression technology, image information can be recorded in a normal music CD (compact disk) together with sound information.

MPEG (Moving Picture Exports Group) refers to a series of international standards for moving picture signal compression developed by the International Standards Organization/International Electrotechnical Commission (ISO/IEC), in which MPEG-1 is a standard for compressing a moving picture signal to 1.5 Mbps, that is, compressing information of a TV signal to as small as about one hundredth. In MPEG-1, the target quality was set at an intermediate level attainable with a transmission speed of mainly about 1.5 Mbps. MPEG-2 was therefore standardized to satisfy requests for further enhanced image quality, in which the TV broadcast quality is attained with transmission of a moving picture signal at 2 to 15 Mbps. Furthermore, presently, the working group (ISO/IEC JTC1/SC29/WG11) that has been engaged in the standardization including MPEG-1 and MPEG-2 has succeeded in attaining a compression rate exceeding those in MPEG-1 and MPEG-2 and also achieved object-based coding/decoding operation, to standardize MPEG-4 implementing new functions required for the multimedia age. MPEG-4, which was initially aimed at standardization of a low bit-rate coding method, has now expanded to more general coding including a high bit rate for interlaced images.

In 2003, ISO/IEC and ITU-T jointly established MPEG-4 AVC and H.264, defined in ITU-T Recommendation H.264, “SERIES H: AUDIOVISUAL AND MULTIMEDIA SYSTEMS. Infrastructure of audiovisual services—Coding of moving video: Advanced video coding for generic audiovisual services”, March 2005, as a higher compression-rate image coding scheme. H.264 standard has now been expanded to a High Profile supporting revised standard suitable for high definition (HD) images and the like. Applications of H.264 have been widened, like those of MPEG-2 and MPEG-4, including digital broadcasting, DVD (digital versatile disk) players/recorders, hard disk players/recorders, camcorders and videophones.

In general, in coding of moving pictures, compression of the information amount is made by reducing the redundancy in the temporal and spatial directions. In view of this, in inter-frame prediction coding intended for reducing the temporal redundancy, detection of a motion and preparation of a predicted image are performed for each block by referring to a forward or backward picture, and the difference between the resultant predicted image and an object picture to be coded is coded. As used herein, a picture is a term representing one screen, which means a frame in a progressive image and a frame or a field in an interlaced image. The interlaced image as used herein refers to an image in which one frame is composed of two fields different in time. In coding and decoding of an interlaced image, one frame may be processed as it is or processed as two fields, or otherwise processed as a frame structure or a field structure depending on each block of the frame.

A picture subjected to intra-frame prediction coding with no reference image involved is called an I picture, a picture subjected to inter-frame prediction coding referring to only one reference image is called a P picture, and a picture subjected to inter-frame prediction coding allowed to refer to two reference images simultaneously is called a B picture. A B picture can refer to two pictures as an arbitrary combination of pictures forward and backward in display time. Designation as reference images (reference pictures) can be made for each macroblock as the basic unit of coding. The reference pictures are distinguished from each other by calling one described earlier in a coded bit stream as the first reference picture and the other described later as the second reference picture. As a condition for coding such pictures, however, a picture that is referred to must have been already coded.

Motion compensation inter-frame prediction coding is used for coding of P pictures and B pictures, which is a coding scheme adopting motion compensation for the inter-frame prediction coding. The motion compensation is a scheme in which prediction is made, not simply from the pixel values of a reference frame, but by detecting the motion amount (hereinafter, called the motion vector) of each part of a picture and considering the detected motion amount in the prediction to thereby improve the prediction precision and reduce the data amount. For example, a motion vector in an object picture to be coded is detected, and a prediction difference between a predicted value obtained after the shifting by the detected motion vector and the object picture to be coded is coded, to thereby reduce the data amount. In this scheme, the motion vector is also coded and recorded or transmitted because information on the motion vector is required at the time of decoding.

The motion vector is detected on the macroblock basis. Specifically, while a macroblock of the object picture to be coded is fixed, a macroblock of a reference picture is moved within a search range to find the position of a reference block most similar to the object block to thereby detect the motion vector.

FIG. 9 is a block diagram of a conventional moving picture coding device.

The moving picture coding device includes a motion estimation unit ME, a multi-frame memory FrmMem, subtractors Sub1 and Sub2, a motion compensation unit MC, an encoder Enc, an adder Add1, a motion vector memory MVMem and a motion vector prediction unit MVPred.

In inter-frame prediction for P pictures, B pictures and the like, the motion estimation unit ME compares a motion detection reference pixel MEpel outputted from the multi-frame memory FrmMem with a screen signal Vin, and outputs a motion vector MV and a reference frame number RefNo. The reference frame number RefNo is an ID signal identifying the reference image referred to by the object image, selected from a plurality of reference images. The motion vector MV is temporarily stored in the motion vector memory MVMem and then outputted as a nearby motion vector PrevMV to be used by the motion vector prediction unit MVPred for prediction of a predicted motion vector PredMV. The subtractor Sub2 subtracts the predicted motion vector PredMV from the motion vector MV and outputs the difference as a motion vector prediction difference DifMV.

The multi-frame memory FrmMem outputs a pixel identified by the reference frame number RefNo and the motion vector MV as a motion compensation reference pixel MCpel1. The motion compensation unit MC produces a reference image with a reduced pixel precision and outputs a reference screen pixel MCpe12. The subtractor Sub1 subtracts the reference screen pixel MCpel2 from the screen signal Vin and outputs a screen prediction error DifPel.

The encoder Enc performs variable length coding for the screen prediction error DifPel, the motion vector prediction difference DifMV and the reference frame number RefNo, to output a coded signal Str. Simultaneously, a decoded screen prediction error RecDifPel as the decoded result of the screen prediction error is also outputted. The decoded screen prediction error RecDifPel, which is obtained by superimposing a coding error on the screen prediction error DifPel, should agree with an inter-frame prediction error obtained by decoding the coded signal Str by an inter-frame prediction decoding device.

The adder Add1 adds the decoded screen prediction error RecDifPel to the reference screen pixel MCpel2. The addition result is stored in the multi-frame memory FrmMem as a decoded screen RecPel. Note however that for effective use of the capacity of the multi-frame memory FrmMem, the region for a screen stored in the multi-frame memory FrmMem is made open if the screen is unnecessary, and the decoded screen RecPel for a screen of which storage in the multi-frame memory FrmMem is unnecessary is not stored in the multi-frame memory FrmMem.

FIG. 10 is a block diagram of a conventional moving picture decoding device. In FIG. 10, the same symbols as those in FIG. 9 denote the same components and signals, and the description thereof is omitted here.

The conventional moving picture decoding device of FIG. 10, which decodes the coded signal Str coded by the conventional moving picture prediction coding device of FIG. 9 and outputs a decoded screen signal Vout, includes a multi-frame memory FrmMem, a motion compensation unit MC, adders Add1 and Add2, a motion vector memory MVMem, a motion vector prediction unit MVPred and a decoder Dec.

The decoder Dec decodes the coded signal Str and outputs a decoded screen prediction error RecDifPel, a reference frame number RefNo and a motion vector prediction difference DifMV. The adder Add2 adds a predicted motion vector PredMV outputted from the motion vector prediction unit MVPred to the motion vector prediction difference DifMV, to obtain a motion vector MV.

In inter-frame prediction, the multi-frame memory FrmMem outputs a pixel identified from the reference frame number RefNo and the motion vector MV as a motion compensation reference pixel MCpel1. The motion compensation unit MC produces a reference image with a reduced pixel precision and outputs a reference screen pixel MCpel2. The adder Add1 adds the decoded screen prediction error RecDifPel to the reference screen pixel MCpel2, and the added result is stored in the multi-frame memory FrmMem as a decoded screen RecPel.

Note however that for effective use of the capacity of the multi-frame memory FrmMem, the region for a screen stored in the multi-frame memory FrmMem is made open if the screen is unnecessary, and the decoded screen RecPel for a screen of which storage in the multi-frame memory FrmMem is unnecessary is not stored in the multi-frame memory FrmMem. Thus, in the manner described above, the coded signal Str can be correctly decoded to obtain the decoded screen signal Vout, that is, the decoded screen RecPel.

If the multi-frame memory FrmMem is configured as an external SDRAM or the like, an area DecSys surrounded with a dotted line in FIG. 10 may be configured as one chip.

In the moving picture coding device of FIG. 9, if the multi-frame memory FrmMem is configured as an external SDRAM or the like, it will be necessary to reduce the bandwidth to/from the multi-frame memory FrmMem because the memory transfer amounts of the decoded screen RecPel, the motion detection reference screen MEpel and the motion compensation reference pixel MCpel1 will be huge. Japanese Laid-Open Patent Publication No. 2006-270683, for example, proposes an example of configuration in which a cache memory is mounted in a one-chip region to reduce the bandwidth to/from the multi-frame memory FrmMem.

As a moving picture coding device provided with a cache memory for reducing the bandwidth to/from the multi-frame memory FrmMem described above, the following configuration may be proposed, for example. A cache memory is additionally provided in the configuration of FIG. 9, to supply required reference data under primary transfer from the multi-frame memory FrmMem to the cache memory and then retrieve the motion detection reference pixel MEpel and the motion compensation reference pixel MCpel1 from the cache memory to be supplied to the motion estimation unit ME and the motion compensation unit MC, respectively. This configuration permits local access to only a picture required for reference.

In image coding, if a large area covering two pictures, for example, can be stored in the cache memory, the image data of the decoded screen RecPel may be stored in the cache memory as it is on the picture-by-picture basis as long as the number of reference pictures is limited. In this case, the primary transfer from the multi-frame memory FrmMem to the cache memory itself can be made unnecessary.

In the moving picture decoding device of FIG. 10, in processing an HD image size large in angle of view, the transfer amounts of the decoded screen signal Vout and the motion compensation reference pixel MCpel1 will be so huge that the external memory bandwidth will be great. In this case, therefore, as in the coding processing described above, the multi-frame memory FrmMem will need to be constructed of a high-speed SRAM, and the power consumption will become large. In particular, for a camcorder **and the like for taking a moving picture, which are battery-driven in many cases, increase in power consumption poses a serious problem.

Unlike MPEG-2, H.264 standard covers reference block sizes from 16×16 to 4×4 at the minimum, and has a filter order for motion compensation of six taps increased from two taps. For example, while transfer by the size of 16×16 requires (16+2−1)×(16+2−1)=286 pixels in MPEG-2, transfer of the equivalence by the size of 4×4 requires (4+6−1)×(4+6−1)×16=1,296 pixels in H.264, that is, a transfer amount 4.5 times as large as that in MPEG-2 (note however that the minimum reference block size and the like may be limited depending on the profile level and the operation standard).

To overcome the above situation, as in the moving picture coding device described above, a cache memory may be added to the multi-frame memory FrmMem, and reference images in the cache memory may be managed on a picture-by-picture basis. For example, a mobile apparatus for performing recording/playback, which will not perform recording and playback simultaneously, can share mounted resources as the moving picture coding device and mounted resources as the moving picture decoding device. In other words, with such sharing of mounted resources, the capacity of the cache memory that is high in mounting cost can be suppressed.

In H.264, selective reference from three or more reference pictures is allowed. In moving picture coding, therefore, the number of pictures referred to can be reduced depending on the coding performance required, and thus a limitation can be imposed on the capacity of the cache memory.

In moving picture decoding, however, the number of pictures that may possibly be referred to is already determined by a moving picture coding standard. It is therefore difficult to freely impose a limitation on the capacity of the cache memory.

For example, in the case that the number of reference pictures is limited to one or less, for example, depending on the required coding performance in a moving picture coding standard, the capacity of the cache memory can be reduced to a capacity corresponding to the coding standard in decoding of coded data coded according to the coding standard. On the contrary, in the case that the number of reference pictures is limited to four or more, for example, to give high coding performance in a moving picture coding standard, the cache memory must be set at a large capacity corresponding to the coding standard in decoding of coded data coded according to the coding standard, to reduce the transfer bandwidth for pixel data to/from the multi-frame memory.

Accordingly, in moving picture decoding, to respond to a request for full decoding of coded data to be decoded, the cache memory must be set at a large capacity as described above. It is therefore difficult to reduce the capacity to an arbitrary small value. As a result, in a moving picture decoding device, the capacity of the cache memory must be set to be larger than that of the cache memory mounted in a moving picture coding device, and this causes a problem of cost increase.

### SUMMARY OF THE INVENTION

An object of the present invention is providing a moving picture decoding device capable of reducing the transfer bandwidth for pixel data to/from a multi-frame memory while limiting the capacity of a cache memory mounted therein to a small value.

To attain the above object, in the moving picture decoding device of the present invention, reference pictures are managed so that only a reference picture high in the possibility of being used in motion compensation is stored in the cache memory on a picture-by-picture basis.

The moving picture decoding integrated circuit of the present invention is a moving picture decoding integrated circuit for decoding blocks constituting a picture using pixel data of a plurality of reference pictures stored in a multi-frame memory, including: a cache memory for storing a reference picture on a picture-by-picture basis; a motion compensation circuit for performing motion compensation of each of blocks constituting a picture using pixel data from the cache memory; and a reference picture management circuit for managing reference pictures so as to store each of the reference pictures high in the possibility of being used in the motion compensation in the cache memory on a picture-by-picture basis.

In one embodiment of the present invention, the moving picture decoding integrated circuit further includes a selection circuit for selecting either one of reference pixel data of one of the reference pictures transferred from the multi-frame memory and reference pixel data of one of the reference pictures transferred from the cache memory, wherein the reference pixel data from the multi-frame memory is used, in place of the reference pixel data from the cache memory, as the reference pixel data processed by the motion compensation circuit.

In another embodiment of the invention, the reference picture management circuit also manages the reference pictures stored in the multi-frame memory, and determining a reference picture high in the possibility of being used in the motion compensation among the reference pictures stored in the multi-frame memory, stores such a reference picture high in the possibility in the cache memory.

In yet another embodiment of the invention, the reference picture management circuit judges whether or not a given decoded picture presently under motion compensation by the motion compensation circuit is a picture high in the possibility of being referred to by a decoded picture to be decoded after the given decoded picture, and if judging that the possibility is high, stores the given coded picture in the cache memory.

In yet another embodiment of the invention, the reference picture management circuit stores a picture coded under a specific picture structure in the cache memory as a reference picture.

In yet another embodiment of the invention, the specific picture structure is composed of only coding blocks each having no reference picture or one reference picture.

In yet another embodiment of the invention, the specific picture structure is composed of coding blocks each having a reference picture that is an I picture or a P picture.

In yet another embodiment of the invention, the reference picture management circuit stores one of the reference pictures in the cache memory according to a reference list of the reference pictures.

In yet another embodiment of the invention, the reference picture management circuit determines a picture position of a block presently under execution of the motion compensation by the motion compensation circuit, and stores part of a reference picture in the cache memory depending on the picture position.

In yet another embodiment of the invention, the moving picture decoding integrated circuit further includes a reference structure analysis circuit for analyzing a cyclic order in a reference structure of pictures and the reference possibility of a picture referred to at each picture position in the cyclic order, wherein the analysis results of the cyclic order and the picture reference possibility by the reference structure analysis circuit are inputted into the reference picture management circuit.

In yet another embodiment of the invention, the reference structure analysis circuit estimates the reference structure from cyclic occurrence intervals of pictures coded under a specific picture structure, and analyzes at which reference position a picture highest in reference frequency is located among pictures referred to by pictures at the same cyclic position as an object picture to be decoded determined from the interval from pictures having the specific picture structure.

In yet another embodiment of the invention, the reference structure analysis circuit analyzes reference frequencies in special playback by recognizing a line of only pictures actually being decoded in the special playback as a pseudo reference structure.

The moving picture decoding method of the present invention is a moving picture decoding method for decoding blocks constituting a picture using pixel data of a plurality of reference pictures stored in a multi-frame memory. The method includes the steps of: managing reference pictures high in the possibility of being referred to by an object picture to be decoded in motion compensation so as to store each of the reference pictures in the cache memory on a picture-by-picture basis; selecting either one reference pixel data of one of the reference pictures transferred from the multi-frame memory and reference pixel data of one of the reference pictures transferred from the cache memory for use in the motion compensation; and performing the motion compensation of the object picture to be decoded using the reference pixel data selected in said selecting.

Alternatively, the moving picture decoding integrated circuit of the present invention is a moving picture decoding integrated circuit for decoding blocks constituting a picture using pixel data of a plurality of reference pictures, including: a multi-frame memory for storing reference pixel data of a plurality of reference pictures; a cache memory for storing reference pixel data of reference pictures on a picture-by-picture basis; a selection circuit for selecting either one of reference pixel data of one of the reference pictures transferred from the multi-frame memory and reference pixel data of one of the reference pictures transferred from the cache memory; a motion compensation circuit for performing motion compensation of each of blocks constituting a picture using the reference pixel data of the reference picture selected by the selection circuit; and a reference picture management circuit for managing reference pictures high in the possibility of being referred to by an object picture to be decoded in the motion compensation so as to store each of the reference pictures in the cache memory on a picture-by-picture basis.

The moving picture decoding program of the present invention is a moving picture decoding program for decoding blocks constituting a picture using pixel data of a plurality of reference pictures stored in a multi-frame memory. The program includes the steps of: managing reference pictures high in the possibility of being referred to by an object picture to be decoded in motion compensation so as to store each of the reference pictures in the cache memory on a picture-by-picture basis; selecting either one of reference pixel data of one of the reference pictures transferred from the multi-frame memory and reference pixel data of one of the reference pictures transferred from the cache memory for use in the motion compensation; and performing the motion compensation of the object picture to be decoded using the reference pixel data selected in said selecting.

As described above, according to the present invention, in decoding of each block of an object picture to be decoded, a reference picture used for motion compensation of the block may already be stored in the cache memory with high possibility. It is therefore no more necessary to acquire a block of the reference picture from the multi-frame memory every decoding of each block of the object picture to be decoded. This makes it possible to reduce the transfer bandwidth for pixel data to/from the multi-frame memory while limiting the capacity of the cache memory to a small value.

In particular, in a mobile apparatus for performing recording/playback of a moving picture, acquisition of a reference picture from the multi-frame memory is unnecessary in playback of a self-recorded sequence. This can maximize the reduction in transfer bandwidth.

According to the present invention, reference pixel data that does not exist in the cache memory can be acquired from the multi-frame memory. This can, not only maximize the reduction in transfer bandwidth for a self-recorded sequence, but also reduce the transfer bandwidth for reference pixel data in a sequence other than the self-recorded one to/from the multi-frame memory without excessively increasing the capacity of the cache memory.

According to the present invention, decoding is performed with a picture high in the possibility of being referred to being left in the cache memory with priority. This eliminates the necessity of reacquiring reference pixel data from the multi-frame memory, and thus permits reduction in transfer bandwidth.

According to the present invention, a reference picture high in reference possibility is left in the cache memory under fixed judgment without analyzing the reference relationship of a picture to be decoded. This permits reduction in the transfer bandwidth to/from the multi-frame memory without complicate memory management.

According to the present invention, the reference possibility of a picture to be referred to can be estimated without measuring the actual reference frequency to each reference picture. This permits reduction in the transfer bandwidth to/from the multi-frame memory without judgment of a complicate reference relationship.

According to the present invention, it is unnecessary to store all regions of a reference picture in the cache memory for processing. This permits reduction in the transfer bandwidth to/from the multi-frame memory while suppressing the mounting cost of the cache memory.

According to the present invention, the reference frequency of a reference picture referred to by an object picture to be decoded, or a reference frequency estimated from the reference frequency of a reference picture referred to by an already-decoded picture located at the same position in a cycle determined from the intervals of P pictures is used. This permits reduction in the transfer bandwidth from the multi-frame memory while improving the effectiveness of a reference picture stored in the cache memory.

### BRIEF DESCRIPTION OF THE DRAWINGS

FIG. 1 is a block diagram of a moving picture decoding device of Embodiment 1 of the present invention.

FIG. 2A is a view illustrating a configuration of a stream, and FIG. 2B is a view illustrating a configuration of one GOP.

FIG. 3 is a diagrammatic view showing how reference indexes are assigned and reference frequencies.

FIGS. 4A to 4C′ are one set of diagrammatic views showing reference pictures managed by a reference picture manager of the moving picture decoding device, in which FIG. 4A shows frequencies in a reference relationship at reference picture P4, FIG. 4B shows frequencies in a reference relationship at reference picture B5, FIG. 4C shows frequencies in a reference relationship at reference picture B6, and FIG. 4C′ shows frequencies in another reference relationship at reference picture B6.

FIGS. 5A to 5C′ are another set of diagrammatic views showing reference pictures managed by the reference picture manager, in which FIG. 5A shows frequencies in a reference relationship at reference picture P4, FIG. 5B shows frequencies in a reference relationship at reference picture B5, FIG. 5C shows frequencies in a reference relationship at reference picture B6, and FIG. 5C′ shows frequencies in another reference relationship at reference picture B6.

FIGS. 6A to 6C are yet another set of diagrammatic views showing reference pictures managed by the reference picture manager, in which FIG. 6A shows frequencies in a reference relationship at reference picture P4, FIG. 6B shows frequencies in another reference relationship at reference picture P4, and FIG. 6C shows frequencies in a reference relationship at reference picture P7.

FIG. 7 is a block diagram of an AV processing part for implementing an H.264 recorder.

FIG. 8A is a view showing an example of physical format of a flexible disk as a recording medium body, FIG. 8B shows a front appearance of a flexible disk case, a cross-sectional structure thereof and the flexible disk, and FIG. 8C is a view showing a configuration for recording/playing back a program on/from the flexible disk.

FIG. 9 is a block diagram of a conventional moving picture coding device.

FIG. 10 is a block diagram of a conventional moving picture decoding device.

### DESCRIPTION OF THE PREFERRED EMBODIMENTS

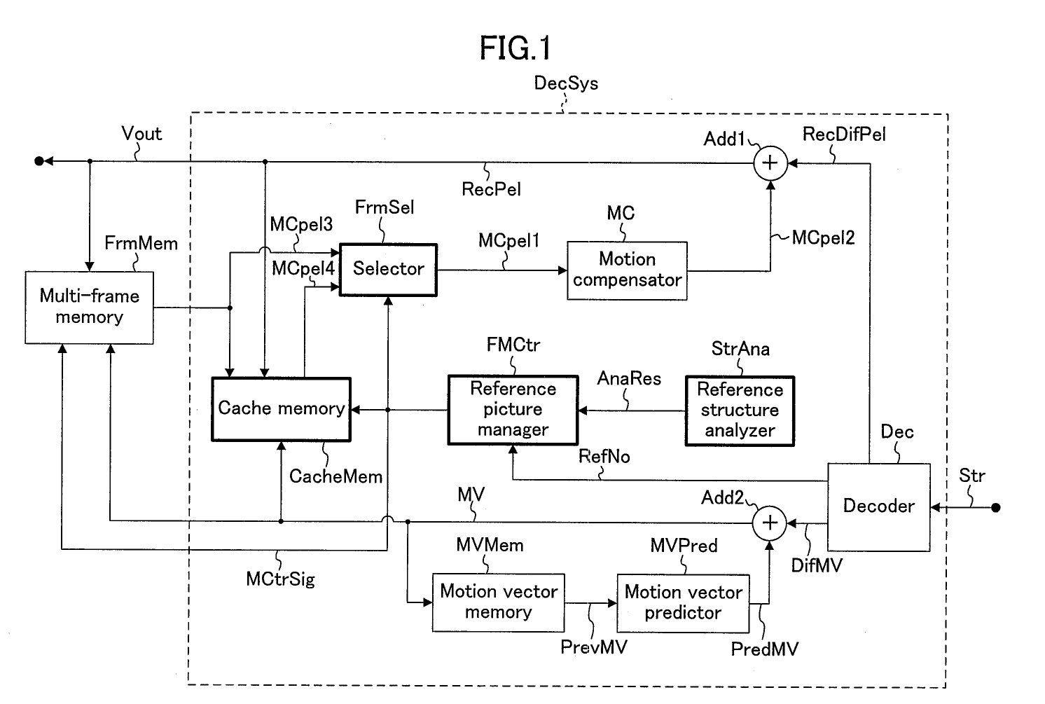

Hereinafter, preferred embodiments of the present invention will be described with reference to FIGS. 1 to 8.

### Embodiment 1

Embodiment 1 will be described with reference to FIGS. 1 to 6.

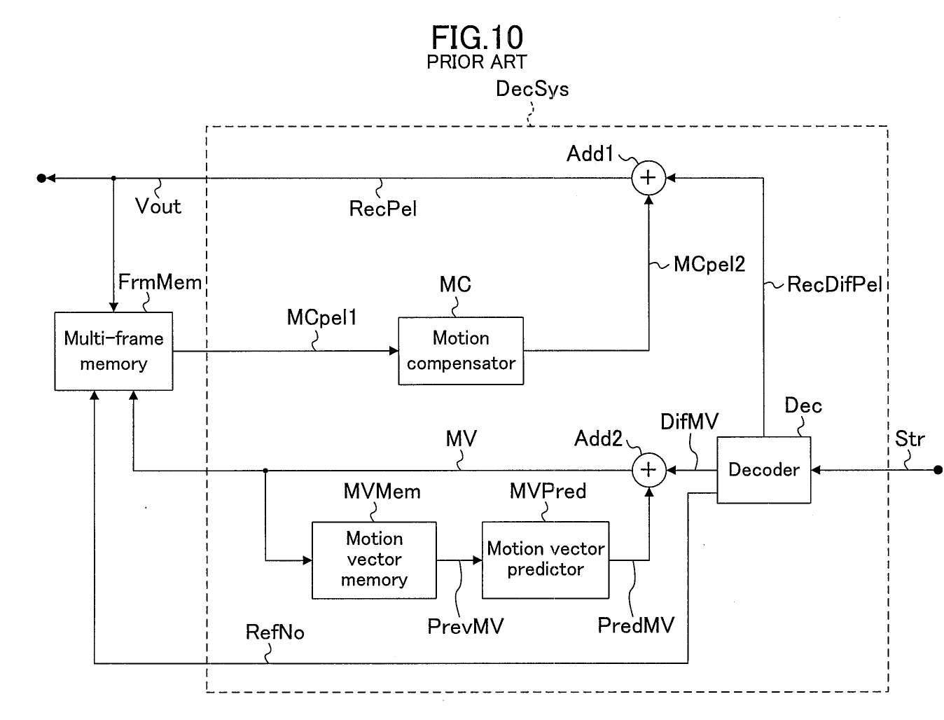

FIG. 1 is a block diagram of a decoding device for implementing the present invention. In FIG. 1, the same symbols as those in FIG. 10 denote the same components and signals, and the description thereof is omitted here. The configuration of FIG. 1 is different from that of FIG. 10 in that a cache memory CacheMem is provided in addition to a multi-frame memory FrmMem for storing pictures and that a selector (selection circuit) FrmSel, a reference picture manager (reference picture management circuit) FMCtr and a reference structure analyzer (reference structure analysis circuit) StrAna are additionally provided.

A flow of processing in the configuration including the cache memory CacheMem, the selector FrmSel, the reference picture manager FMCtr and the reference structure analyzer StrAna will be described. First, the reference structure analyzer StrAna analyzes the structure of a stream that is being decoded, and outputs the structure analysis result AnaRes of the stream to the reference picture manager FMCtr. The reference picture manager FMCtr simultaneously receives a reference frame number RefNo, and as a result outputs a control signal MCtrSig for memory manipulation.

If it is judged from the control signal MCtrSig that a picture is high in the possibility of being referred to by a following picture, the decoded screen signal Vout for the picture is stored in an appropriate region of the cache memory CacheMem in addition to the multi-frame memory FrmMem. Also, for a picture that is high in the possibility of being referred to by a following picture and exists in the multi-frame memory FrmMem but does not exist in the cache memory CacheMem, a reference screen pixel MCpel3 is outputted from the multi-frame memory FrmMem to be stored in the cache memory CacheMem.

In actual motion compensation using a motion compensation unit (motion compensation circuit) MC, the selector FrmSel is controlled with the control signal MCtrSig so as to select a reference screen pixel MCpel4 outputted from the cache memory CacheMem if the reference picture exists in the cache memory CacheMem or select the MCpel3 outputted from the frame memory FrmMem if not, and outputs a selected reference screen pixel MCpel1 to the motion compensation unit MC. The other part of the signal flow is the same as the operation of the conventional moving picture decoding device shown in FIG. 10.

<Analysis of Reference Structure>

The reference structure analyzer StrAna will be described.

In the analysis of the reference structure, the reference frame numbers RefNo are previously decoded for an object picture to be decoded, and the pictures referred to by each macroblock are summarized, to analyze which picture is high in reference frequency. If previous analysis is difficult, the reference structure may be inferred from the reference structure of a picture preceding the object picture to be decoded in a manner described below.

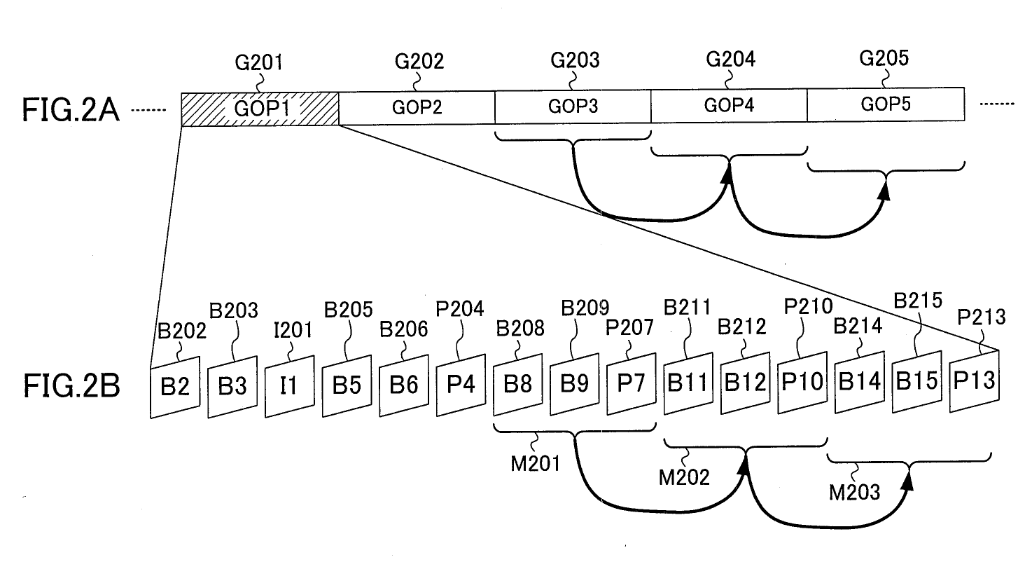

FIGS. 2A and 2B are diagrammatic views of pictures constituting a stream. FIG. 2A shows that a stream Str is made of groups of pictures (GOPs) (reference structures), such as GOP1 G201, GOP2 G202, GOP3 G203, GOP4 G204 and GOP5 G205.

FIG. 2B shows that one GOP is made of pictures, such as I1 I201, B2 B202, B3 B203, P4 P204, B5 B205, B6 B206, P7 P207, B8 B208, B9 B209, P10 P210, B11 B211, B12 B212, P13 P213, B14 B214 and B15 B215, which are numbered in order of decoding. These pictures are however shown in order of display in FIG. 2B.

Assume for example that M201 denotes a set composed of P7 P207, B8 B208 and B9 B209, M202 denotes a set composed of P10 P210, B11 B211 and B12 B212, and M203 denotes a set composed of P13 P213, B14 B214 and B15 B215. The pictures are lined repeating the cycle of B picture, B picture and P picture. It is therefore judged that the reference structure of M202 should roughly be equal to that of M201 and likewise the reference structure of M203 should roughly be equal to that of M202. Thus, it is possible to estimate a picture high in the possibility of being referred to by each picture.

The reference possibility can also be estimated by a method other than that described above using the periodicity in the picture level. For example, it may be judged that the reference structure of GOP4 G204 resembles that of GOP3 G203 and likewise the reference structure of GOP5 G205 resembles that of GOP4 G204. In this case, information referred to by a picture at the same position in a resembling GOP may be used in estimation of a reference picture high in the possibility of being referred to.

<Possibility Estimation of Reference Frame Number>

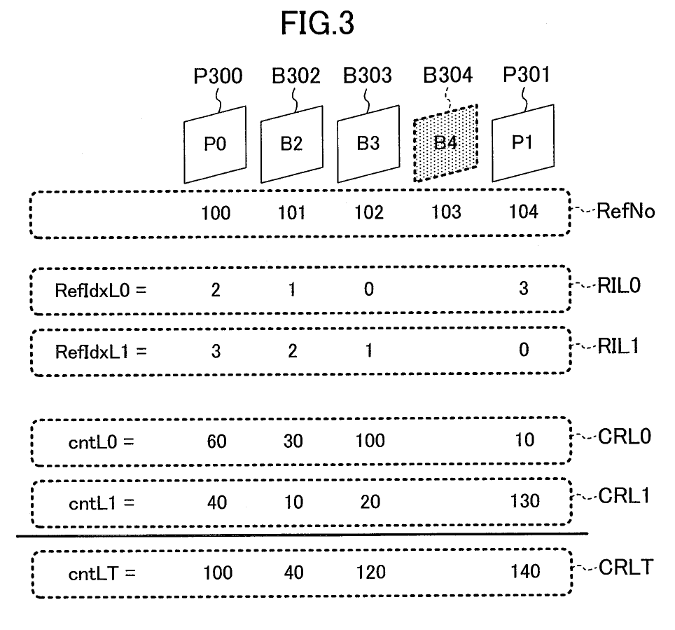

A method for estimating a reference frame number for judging which picture is high in the possibility of being referred to will be described with reference to FIG. 3.

FIG. 3 is a diagrammatic view showing how reference indexes are assigned and reference frequencies. In FIG. 3, P0 P300 and P1 P301 represent P pictures and B2 B302, B3 B303 and B4 B304 represent B pictures. Assume that reference frame numbers RetNo 100, 101, 102, 103 and 105 are assigned to these pictures.

Hereinafter, which reference picture is high in the possibility of being referred to by B4 B304 will be described. RIL0 and RILL are examples of reference lists in H.264 standard. In the case of a B picture, pixel data for performing motion compensation is acquired by selecting and designating one reference picture each from the reference lists RIL0 and RIL1. The reference list RIL0 assigns numbers giving higher priority to a temporally future picture, in which B3 B303 is set at 0, B2 B302 at 1, P0 P300 at 2 and P1 P301 at 3. Likewise, the reference list RIL1 assigns numbers giving higher priority to a temporally past picture, in which P1 P301 is set at 0, B3 B303 at 1, B2 B302 at 2 and P0 P300 at 3.

In the first place, the numbers in the reference lists are highly possibly manipulated so as to assign a smaller number to a picture more likely to be referred to for the reason of enhancing the compression rate at the time of moving picture coding. In other words, cache management can be made by storing a picture smaller in the number in a reference list in the cache memory CacheMem preferentially.

For example, in decoding of the picture B4 itself, or in decoding of a picture located at the same structural position as the picture B4, if the number of pictures allowed to be left in the limited capacity of the cache memory CacheMem as a reference picture is two, it is judged whether or not B3 B303 as the number 0 in the reference list RIL0 and P1 P301 as the number 0 in the reference list RIL1 or pictures at the same structural positions as these pictures may be selected to be left in the cache memory CacheMem. Finally, it is judged that the reference frame numbers RefNo 102 and 104 are high in reference possibility in the case of decoding of the picture B4 itself.

Hereinafter, the processing of summing the frequencies of reference pictures actually referred to in each macroblock to judge the reference possibility will be described. CRL0 and CRL1 indicate the numbers of times by which pictures in each reference list were referred to. For example, the numbers of times are 100, 30, 60 and 10 for the pictures numbered 0 to 3 in the reference list RIL0, and the numbers of times are 130, 20, 10 and 40 for the pictures numbered 0 to 3 in the reference list RIL1. In CRLT, the total values of the numbers of times in CRL0 and CRL1 are shown for P0 P300, B2 B302, B3 B303 and P1 P301, which are respectively 100, 40, 120 and 140.

As described above, in decoding of the picture B4 itself, or in decoding of a picture located at the same structural position as the picture B4, if the number of pictures allowed to be left in the limited capacity of the cache memory CacheMem as a reference picture is two, it is judged from the numbers of reference times that P1 P301 and B3 B303 or pictures at the same structural positions as these pictures may be left in the cache memory CacheMem. Likewise, if up to three pictures are allowed, it is judged that P0 P300 next largest in the number of reference times may be left. Finally, it is judged that the reference frame numbers RefNo 100, 102 and 104 are high in reference possibility in the case of decoding of the picture B4 itself.

<Description of Operation of Cache Memory>

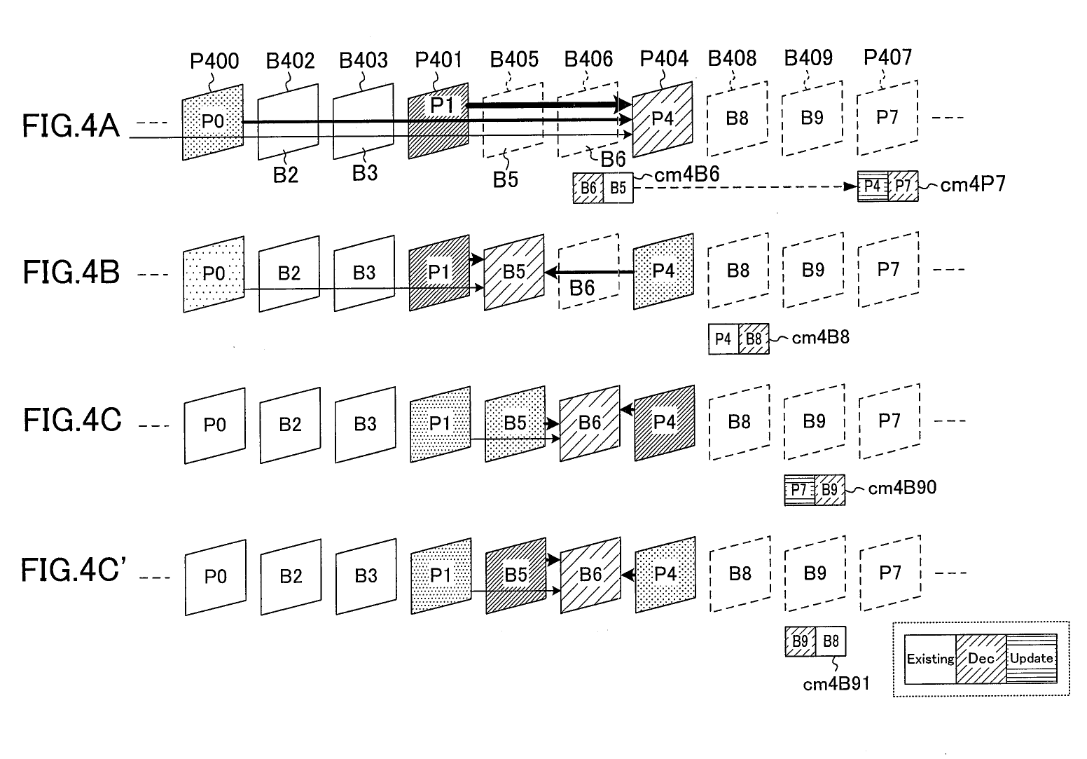

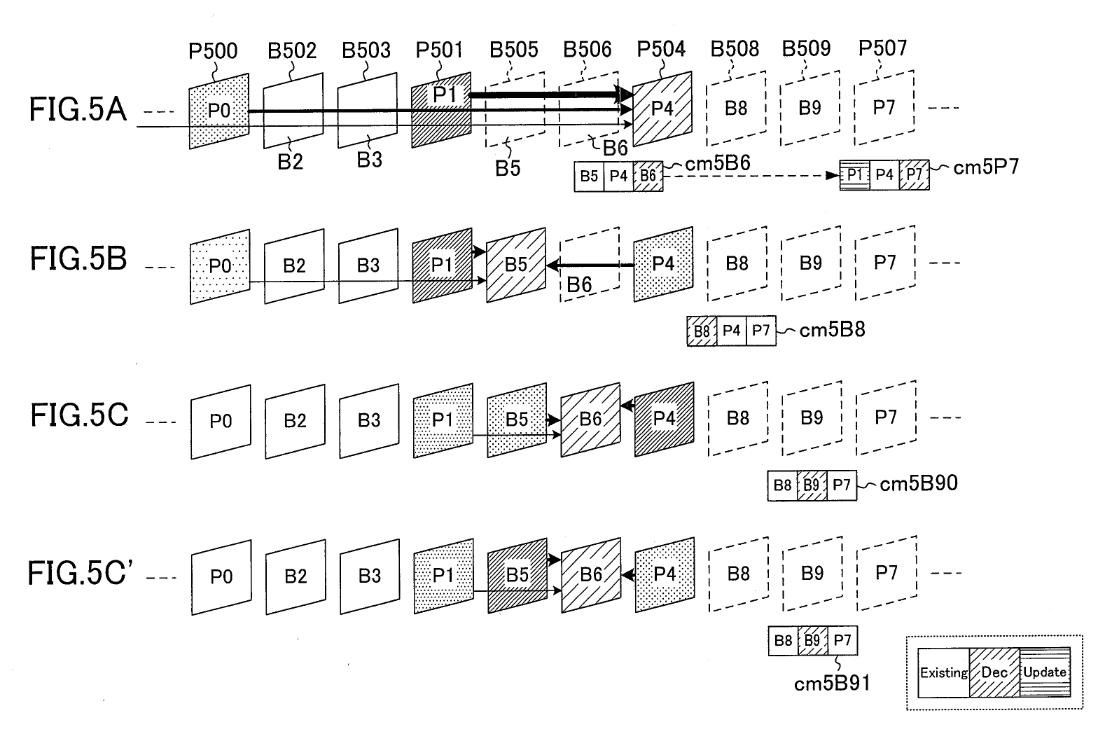

Hereinafter, how the management of the cache memory CacheMem works will be described with reference to FIGS. 4A to 4C′ and 5A to 5C′, which are respectively first and second sets of diagrammatic views showing reference pictures managed according to the present invention. In FIGS. 4A to 4C′, management regions for two pictures are prepared, while in FIGS. 5A to 5C′, management regions for three pictures are prepared.

The operation in the case of having management regions for two pictures is as follows. For simplification, description will be made assuming that one management region is for reference and the other is always used for storage of the local decode result immediately after decoding. In FIGS. 4A to 4C′, P0 P400, P1 P401, P4 P404 and P7 P407 represent P pictures, and B2 B402, B3 B403, B5 B405, B6 B406, B8 B408 and B9 B409 represent B pictures. The pictures are lined in order of display, and the numbers combined with P or B to give names of respective pictures such as P0 and B2 are in order of decoding. Also, cm4B6, cm4P7, cm4B8, and cm4B90/cm4B91 respectively represent the memory management states of B6 B406, P7 P407, B8 B408 and B9 B409. FIG. 4A shows frequencies in a reference relationship at P4 P404, FIG. 4B shows frequencies in a reference relationship at B5 B405, and FIGS. 4C and 4C′ show frequencies in reference relationships at B6 B406. In the memory management states, a blank square represents a region for a picture exiting in the cache memory CacheMem, a hatched square represents a region in which a picture under decoding is stored, and a square with horizontal stripes represents a region in which a picture high in reference frequency is acquired from the multi-frame memory FrmMem for updating.

Referring to FIG. 4A, assume that it has been found from analysis that the picture most frequently referred to in a reference relationship at P4 P404 is P1 P401 and the picture second most frequently referred to is P0 P400. In this case, it is predicted that a similar reference relationship will be established at P7 P407. It is therefore found advisable to store P4 P404 in advance in the reference picture management region at decoding of P7 P407. In view of this, to update the memory management state from cm4B6 of B6 B406, in which B5 B405 and B6 B406 are stored, to cm4P7, control is made to acquire P4 P404 from the multi-frame memory FrmMem for updating and store the local decode result of P7 P407.

Referring to FIG. 4B, assume that it has been found from analysis that the picture most frequently referred to in a reference relationship at B5 B405 is P1 P401 and the pictures second and third most frequently referred to are P4 P404 and P0 P400, respectively. In this case, it is predicted that a similar reference relationship will be established at B8 B408. It is therefore found advisable to store P4 P404 in advance in the reference picture management region at decoding of B8 B408. In view of this, to update the memory management state from cm4P7, in which P4 P404 and P7 P407 are stored, to cm4B8, control is made to leave P4 P404 behind and overwrite P7 P407 with the local decode result of B8 B408.

Referring to FIG. 4C, assume that it has been found from analysis that the picture most frequently referred to in a reference relationship at B6 B406 is P4 P404 and the pictures second and third most frequently referred to are B5 B405 and P1 P401, respectively. In this case, it is predicted that a similar reference relationship will be established at B9 B409. It is therefore found advisable to store P7 P407 in advance in the reference picture management region at decoding of B9 B409. In view of this, to update the memory management state from cm4B8, in which P4 P404 and B8 B408 are stored, to cm4B90, control is made to acquire P7 P407 from the multi-frame memory FrmMem for updating and store the local decode result of B9 B409.

FIG. 4C′ shows the region management observed when it has been found from analysis that the picture most frequently referred to in a reference relationship at B6 B406 is B5 B405 and the pictures second and third most frequently referred to are P4 P404 and P1 P401, respectively. In this case, it is found advisable to store B8 B408 in advance in the reference picture management region at decoding of B9 B409. To update the memory management state from cm4B8, in which P4 P404 and B8 B408 are stored, to cm4B91, control is made to leave B8 B408 behind and overwrite P4 P404 with the local decode result of B9 B409.

Next, the operation in the case of having management regions for three reference pictures will be described. For simplification, the description will be made assuming that one management region is for reference and the remaining two regions are always used for storage of local decode result. In FIGS. 5A to 5C′, P0 P500, P1 P501, P4 P504, P7 P507, B2 B502, B3 B503, B5 B505, B6 B506, B8 B508, B9 B509, cm5B6, cm5P7, cm5B8, cm5B90 and cm5B91 respectively correspond to P0 P400, P1 P401, P4 P404, P7 P407, B2 B402, B3 B403, B5 B405, B6 B406, B8 B408, B9 B409, cm4B6, cm4P7, cm4B8, cm4B90 and cm4B91 in FIGS. 4A to 4C′. The operation will be described assuming that the reference frequencies at the respective pictures are the same as those described with reference to FIGS. 4A to 4C′.

In decoding of P7 P507, in FIG. 5A, the memory management state should be changed from cm5B6 (B5 B505, P4 P504, B6 B506) to cm5P7 (P1 P501, P4 P504, P7 P507). Therefore, control is made to overwrite B5 B505 with P1 P501 acquired from the multi-frame memory FrmMem and overwrite B6 B506 with the local decode result of P7 P507.

In decoding of B8 B508, in FIG. 5B, the memory management state should be changed from cm5P7 (P1 P501, P4 P504, P7 P507) to cm5K8 (B8 B508, P4 P504, P7 P507). Therefore, control is made to overwrite P1 P501 with the local decode result of B8 B508.

In decoding of B9 B509, in FIG. 5C, the memory management state should be changed from cm5B8 (B8 B508, P4 P504, P7 P507) to cm5B90 (B8 B508, B9 B509, P7 P507). Therefore, control is made to overwrite P4 P504 with the local decode result of B9 B509. FIG. 5C′ shows the region management observed when it has been found from analysis that the picture most frequently referred to in a reference relationship at B6 B506 is B5 B505 and the pictures second and third most frequently referred to are P4 P504 and P1 P501, respectively. In this case, since the pictures first and second most frequently referred to can be stored, the memory management states cm5B90 and cm5B91 can be the same, and thus the operation is the same as that in FIG. 5C.

Although the management of the cache memory CacheMem was performed on a picture-by-picture basis in the above description, the reference regions may otherwise be managed in every half of a picture, every slice obtained by dividing a picture or depending on a region at a specific position from an object picture to be decoded.

Although the management of the cache memory CacheMem was described using the cases of two pictures and three pictures, regions for four or more pictures may be provided. In such cases, having a given number of management regions, it may be possible to eliminate the necessity of re-charging the cache memory CacheMem with data re-acquired from the multi-frame memory at the time of playback of self-recorded data and playback of data in a medium recorded via a different maker's product.

In this embodiment, the management of the cache memory CacheMem was made by analyzing the inter-picture reference relationship. Alternatively, memory management may be made to leave an I picture and a P picture high in the possibility of being fixedly referred to.

In the above description, the reference picture management was made for pixel data. Similar processing can also be made for management information data attached to reference pictures. Such management information data attached to a reference picture include motion vector information of each macroblock of the reference picture, reference picture information referred to by the reference picture, and the macroblock type, for example.

The reduction of data acquisition from the multi-frame memory FrmMem can also produce an effect of power reduction.

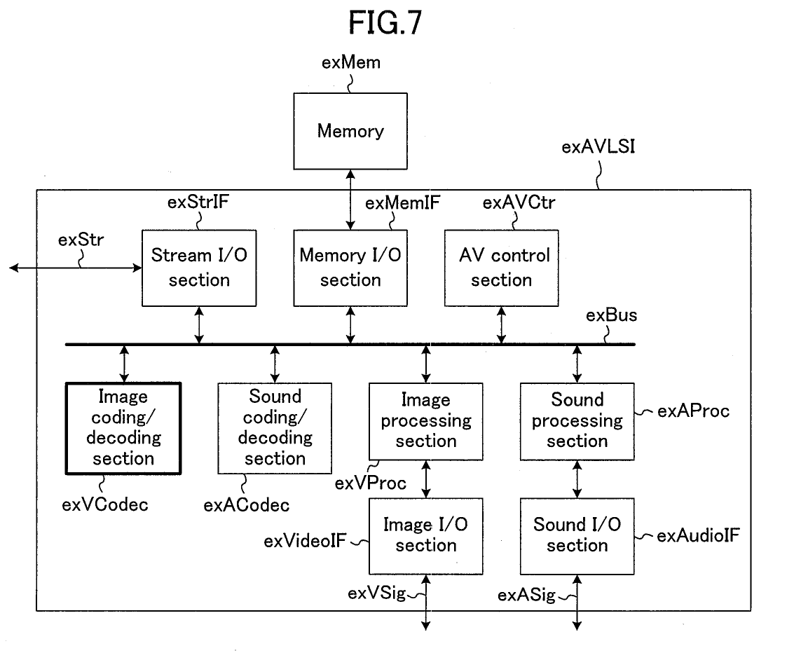

The respective function blocks in the block diagrams of FIGS. 1 and 7 are typically implemented as LSIs or integrated circuits, which may be individually configured as one chip, or some or all of which may be configured as one chip. The multi-frame memory FrmMem and the like, which have a large capacity, may be implemented as a large-capacity SDRAM external to the LSIs, or may possibly be configured as one package or one chip.

The LSI described above may otherwise be an IC, a system LSI, a super LSI or an ultra LSI depending on the degree of integrity. The circuit integration may be attained, not only by LSIs, but also by exclusive circuits and general processors. Otherwise, after fabrication of an LSI, a field programmable gate array (FPGA) and a reconfigurable processor that can reconfigure the connection and setting of circuit cells inside the LSI may be used. Furthermore, if a technology of circuit integration that can replace LSIs emerges in future in the progress of the semiconductor technology or from a branching technology, such a technology may be used to integrate the function blocks. A possibility exists in adaptation of biotechnology.

### Embodiment 2

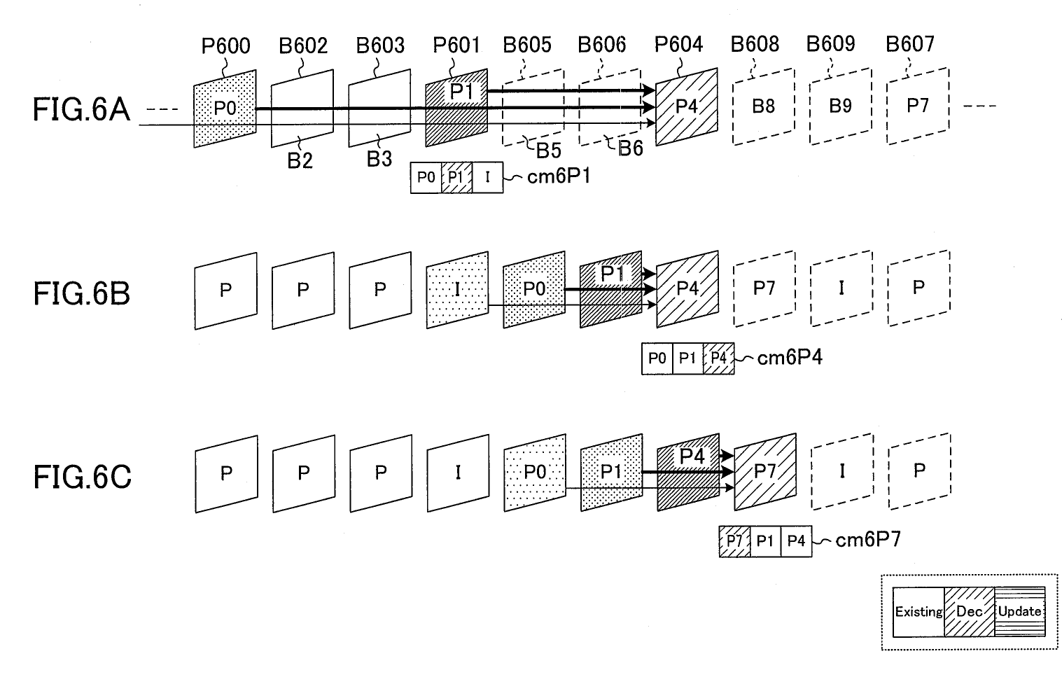

Embodiment 2 of the present invention will be described with reference to FIG. 6. In this embodiment, the memory management method is changed in special playback because use of the normal management of the cache memory CacheMem may cause redundant memory input/output control.

FIGS. 6A to 6C are third set of diagrammatic views showing reference pictures managed according to the present invention. In FIGS. 6A to 6C, P0 P600, P1 P601, P4 P604, P7 P607, B2 B602, B3 B603, B5 B605, B6 B606, B8 B608 and B9 B609 respectively correspond to P0 P400, P1 P401, P4 P404, P7 P407, B2 B402, B3 B403, B5 B405, B6 B406, B8 B408 and B9 B409. Also, cm6 P1, cm6P4 and cm6P7 represent the memory management states of P pictures existing next to P1 P601, P4 P604 and P7 P607, respectively.

Multiple-speed playback is one type of special playback. Referring to FIGS. 6A to 6C, a method for simple multiple-speed playback will be described briefly. FIG. 6A shows pictures lined in order of display during normal playback. There is a technique of performing multiple-speed playback in a simple way, called IP playback, in which only I pictures and P pictures are played back ignoring B pictures, to thereby achieve multiple-speed playback. FIGS. 6B and 6C show the states in which all B pictures have been removed from the state of FIGS. 6A and I pictures and P pictures have been added preceding and following the remaining P pictures.

In other words, during multiple-speed playback, a GOP structure composed of 15 pictures of IBBPBBPBBPBBPBB, for example, is regarded as being composed of five pictures of IPPPP in a pseudo manner, and no management of the cache memory CacheMem for intervening B pictures is performed.

Hereinafter, the management state of the cache memory CacheMem will be described assuming that a nearer picture is higher in reference frequency for simplification.

In FIG. 6B, the memory management state is updated from cm6P1 (P0 P600, P1 P601, immediately preceding I picture) to cm6P4 (P0 600, P1 P601, P4 P604). Control is therefore made to overwrite the immediately preceding I picture region with the local is decode result of P4 P604. In FIG. 6C, the memory management state is updated from cm6P4 (P0 600, P1 P601, P4 P604) to cm6P7 (P7 P607, P1 P601, P4 P604). Control is therefore made to overwrite the immediately preceding P0 P600 region with the local decode result of P7 P607.

### Embodiment 3

Embodiment 3 of the present invention will be described. In this embodiment, an image coding/decoding device in which the moving picture decoding device described above is combined with a moving picture coding device will be described as an application of the moving picture decoding device.

FIG. 7 is a block diagram of an AV processor for implementing an H.264 recorder. In FIG. 7, exAVLSI denotes an AV processing part of a DVD recorder, a hard disk recorder and the like for playing back digital-compressed sound/images.

In FIG. 7, also, exStr denotes sound/image stream data, and exVsig and exAsig respectively denote image data and sound data. A bus exBus transfers data such as the stream data and decoded data of sound and images. A stream input/output (I/O) section exStrIF for receiving the stream data exStr is connected to the bus exBus at one terminal and to a large-capacity storage device at the other terminal. An image coding/decoding section exVCodec codes/decodes an image and is connected to exBus. A memory exMem stores therein data such as stream data, coded data and decoded data and is connected to exBus.

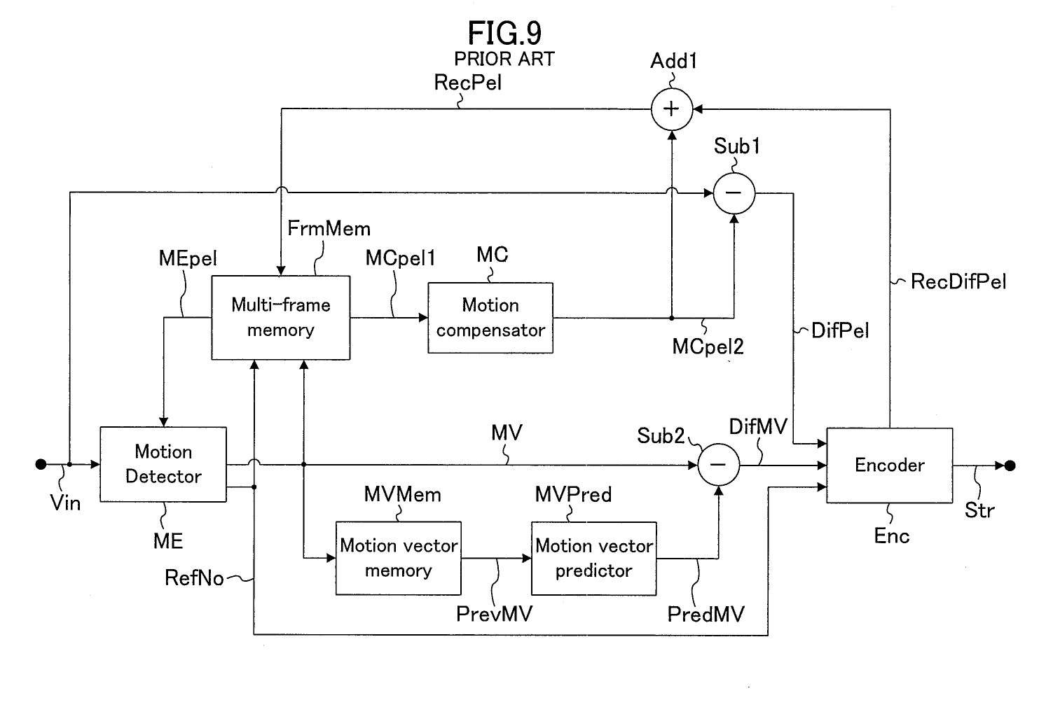

The image coding/decoding section exVCodec includes the moving picture decoding device of FIG. 1, the moving picture coding device of FIG. 9 and the like. The stream data exStr includes the coded signal Str shown in FIG. 1, and the memory exMem includes the multi-frame memory FrmMem shown in FIG. 1.

An image processing section exVproc performs pre-processing and post-processing for an image signal and is connected to exBus. An image I/O section exVideoIF outputs an image data signal processed by the image processing section exVProc or just allowed to pass through the image processing section without being processed outside as the image signal exVsig, or captures the image signal exVsig from outside.

A sound processing section exAproc performs pre-processing and post-processing for a sound signal and is connected to exBus. A sound I/O section exAudioIF outputs a sound data signal processed by the sound processing section exAProc or just allowed to pass through the sound processing section without being processed outside as the sound signal exAsig, or captures the sound signal exAsig from outside. An AV control section exAVCtr controls the entire of the AV processing part exAVLSI.

In the coding processing, first, the image signal exVsig is inputted into the image I/O section exVideoIF, and the sound signal exAsig is inputted into the sound I/O section exAideoIF.

As recording processing, the image processing section exVProc performs filtering, extraction of a characteristic amount for coding and the like for the image signal exVsig inputted via the image I/O section exVideoIF, and stores the processed result in the memory exMem via a memory I/O section exMemIF as original image data. The original image data is then transferred, together with reference image data, from the memory exMem to the image coding/decoding section exVCodec via the memory I/O section exMemIF. In reverse, image stream data coded by the image coding/decoding section exVCodec is transferred, together with locally decompressed data, from the image coding/decoding section exVCodec to the memory exMem.

Likewise, the sound processing section exAProc performs filtering, extraction of a characteristic amount for coding and the like for the sound signal exAsig inputted via the sound I/O section exAudioIF, and stores the processed result in the memory exMem via the memory I/O section exMemIF as original sound data. The original sound data is then retrieved from the memory exMem via the memory I/O section exMemIF and coded, and again stored in the memory exMem as sound stream data.

The image stream, the sound stream and other stream information are processed as one stream data, and the resultant stream data exStr is outputted via the stream I/O section exStrIF, to be written in the large-capacity storage device such as an optical disk (DVD) and a hard disk (HDD).

Next, in the decoding processing, the following operation is performed. First, data stored by the recording processing is read from the large-capacity storage device such as an optical disk, a hard disk and a semiconductor memory, so that the sound and image stream signal exStr is inputted via the stream I/O section exStrIF. Out of the stream signal exStr, an image stream is inputted into the image coding/decoding section exVCodec while a sound stream is inputted into a sound coding/decoding section exACodec.

Image data decoded by the image coding/decoding section exVCodec is temporarily stored in the memory exMem via the memory I/O section exMemIF. The data stored in the memory exMem is subjected to processing such as noise removal by the image processing section exVProc. Image data stored in the memory exMem may be transferred again to the image coding/decoding section exVCodec to be used as a reference picture for inter-frame motion compensation prediction.

Sound data decoded by the sound coding/decoding section exACodec is temporarily stored in the memory exMem via the memory I/O section exMemIF. The data stored in the memory exMem is subjected to acoustic-related processing by the sound processing section exAProc.

With temporal synchronization being secured between sound and images, the data processed by the image processing section exVProc is outputted via the image I/O section exVideoIF as the signal exVSig to be displayed on a TV screen and the like, and the data processed by the sound processing section exAProc is outputted via the sound I/O section exAudioIF as the signal exASig to be outputted from a speaker and the like.

### Embodiment 4

Embodiment 4 of the present invention will be described. In this embodiment, a program for implementing the moving picture decoding device described in any of the above embodiments by software is recorded in a recording medium such as a flexible disk, to enable execution of the processing described in the above embodiments simply in an individual computer system.

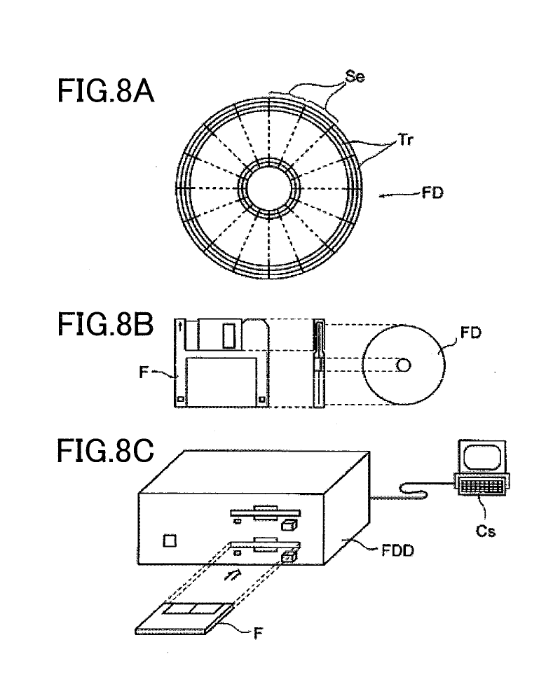

FIGS. 8A to 8C illustrate how to execute the processing in a computer system using a flexible disk storing therein a program for implementing the moving picture decoding device of any of Embodiments 1 to 3 described above.

FIG. 8B shows a front appearance of a cased flexible disk, a cross-sectional structure thereof and the flexible disk itself, and FIG. 8A shows an example of physical format of the flexible disk as the recording medium body. The flexible disk FD, which is placed in a case F, has a surface having a plurality of tracks Tr formed in the shape of concentric circles. Each track is angularly divided into 16 sectors Se. Thus, the flexible disk storing therein the program described above has the moving picture decoding device in the form of a program recorded in an allocated region of the flexible disk FD.

FIG. 8C shows a configuration for recording/playing back the program described above on/from the flexible disk FD. In recording of the program on the flexible disk FD, the moving picture decoding device in the form of a program is written on the flexible disk from a computer system Cs via a flexible disk drive. In construction of the moving picture decoding device in a computer system using the program on the flexible disk, the program is read from the flexible disk via the flexible disk drive and transferred to the computer system.

Although the flexible disk was used as the recording medium in the above description, an optical disk can also be used for the above implementation. Other recording media such as an IC card and a ROM cassette that can record the program can also be used.

While the present invention has been described in preferred embodiments, it will be apparent to those skilled in the art that the disclosed invention may be modified in numerous ways and may assume many embodiments other than those specifically set out and described above. Accordingly, it is intended by the appended claims to cover all modifications of the invention which fall within the true spirit and scope of the invention.

What is claimed is:

1. A moving picture decoding integrated circuit for decoding blocks constituting a picture using pixel data of a plurality of reference pictures stored in a multi-frame memory, comprising:
a cache memory for storing a reference picture on a picture-by-picture basis;
a motion compensation circuit for performing motion compensation of each of blocks constituting a picture using pixel data from the cache memory; and
a reference picture management circuit for managing reference pictures so as to store each of the reference pictures high in the possibility of being used in the motion compensation in the cache memory on a picture-by-picture basis.

2. The moving picture decoding integrated circuit of claim 1, further comprising a selection circuit for selecting either one of reference pixel data of one of the reference pictures transferred from the multi-frame memory and reference pixel data of one of the reference pictures transferred from the cache memory,
wherein the reference pixel data from the multi-frame memory is used, in place of the reference pixel data from the cache memory, as the reference pixel data processed by the motion compensation circuit.

3. The moving picture decoding integrated circuit of claim 1, wherein the reference picture management circuit also manages the reference pictures stored in the multi-frame memory, and determining a reference picture high in the possibility of being used in the motion compensation among the reference pictures stored in the multi-frame memory, stores such a reference picture high in the possibility in the cache memory.

4. The moving picture decoding integrated circuit of claim 1, wherein the reference picture management circuit judges whether or not a given decoded picture presently under motion compensation by the motion compensation circuit is a picture high in the possibility of being referred to by a decoded picture to be decoded after the given decoded picture, and if judging that the possibility is high, stores the given coded picture in the cache memory.

5. The moving picture decoding integrated circuit of claim 1, wherein the reference picture management circuit stores a picture coded under a specific picture structure in the cache memory as a reference picture.

6. The moving picture decoding integrated circuit of claim 5, wherein the specific picture structure is composed of only coding blocks each having no reference picture or one reference picture.

7. The moving picture decoding integrated circuit of claim 5, wherein the specific picture structure is composed of coding blocks each having a reference picture that is an I picture or a P picture.

8. The moving picture decoding integrated circuit of claim 1, wherein the reference picture management circuit stores one of the reference pictures in the cache memory according to a reference list of the reference pictures.

9. The moving picture decoding integrated circuit of claim 1, wherein the reference picture management circuit determines a picture position of a block presently under execution of the motion compensation by the motion compensation circuit, and stores part of a reference picture in the cache memory depending on the picture position.

10. The moving picture decoding integrated circuit of claim 1, further comprising a reference structure analysis circuit for analyzing a cyclic order in a reference structure of pictures and the reference possibility of a picture referred to at each picture position in the cyclic order,
wherein the analysis results of the cyclic order and the picture reference possibility by the reference structure analysis circuit are inputted into the reference picture management circuit.

11. The moving picture decoding integrated circuit of claim 10, wherein the reference structure analysis circuit estimates the reference structure from cyclic occurrence intervals of pictures coded under a specific picture structure, and analyzes at which reference position a picture highest in reference frequency is located among pictures referred to by pictures at the same cyclic position as an object picture to be decoded determined from the interval from pictures having the specific picture structure.

12. The moving picture decoding integrated circuit of claim 10, wherein the reference structure analysis circuit analyzes reference frequencies in special playback by recognizing a line of only pictures actually being decoded in the special playback as a pseudo reference structure.

13. A moving picture decoding method for decoding blocks constituting a picture using pixel data of a plurality of reference pictures stored in a multi-frame memory, comprising the steps of:
managing reference pictures high in the possibility of being referred to by an object picture to be decoded in motion compensation so as to store each of the reference pictures in the cache memory on a picture-by-picture basis;
selecting either one of reference pixel data of one of the reference pictures transferred from the multi-frame memory and reference pixel data of one of the reference pictures transferred from the cache memory for use in the motion compensation; and
performing the motion compensation of the object picture to be decoded using the reference pixel data selected in said selecting.

14. A moving picture decoding integrated circuit for decoding blocks constituting a picture using pixel data of a plurality of reference pictures, comprising:
a multi-frame memory for storing reference pixel data of a plurality of reference pictures;
a cache memory for storing reference pixel data of reference pictures on a picture-by-picture basis;
a selection circuit for selecting either one of reference pixel data of one of the reference pictures transferred from the multi-frame memory and reference pixel data of one of the reference pictures transferred from the cache memory;
a motion compensation circuit for performing motion compensation of each of blocks constituting a picture using the reference pixel data of the reference picture selected by the selection circuit; and
a reference picture management circuit for managing reference pictures high in the possibility of being referred to by an object picture to be decoded in the motion compensation so as to store each of the reference pictures in the cache memory on a picture-by-picture basis.

15. A moving picture decoding program for decoding blocks constituting a picture using pixel data of a plurality of reference pictures stored in a multi-frame memory, comprising the steps of:
managing reference pictures high in the possibility of being referred to by an object picture to be decoded in motion compensation so as to store each of the reference pictures in the cache memory on a picture-by-picture basis;
selecting either one of reference pixel data of one of the reference pictures transferred from the multi-frame memory and reference pixel data of one of the reference pictures transferred from the cache memory for use in the motion compensation; and
performing the motion compensation of the object picture to be decoded using the reference pixel data selected in said selecting.
